(19) United States
(12) Patent Application Publication
(10) Pub. No.: US 2016/0033300 A1
(43) Pub. Date: Feb. 4, 2016

(54) ARINC 429 DATA SUBSTITUTION

(71) Applicant: Safe Flight Instrument Corporation, White Plains, NY (US)

(72) Inventors: Randall A. GREENE, Greenwich, CT (US); Robert D. TETER, Hopewell Junction, NY (US); Louis SIMONS, Mamaroneck, NY (US)

(21) Appl. No.: 14/450,165

(22) Filed: Aug. 1, 2014

(51) Int. Cl. G01C 23/00; B64D 43/00

(52) U.S. Cl. CPC G01C 23/005; B64D 43/00

(57) ABSTRACT

In one embodiment, an aircraft display system includes a first module that identifies a label in an ARINC 429 communication between a flight director and a display, a second module that removes flight director data from the ARINC 429 communication, the flight director data associated with the label, and a third module that inserts substitute data in the ARINC 429 communication. The display receives the substitute data before an error is detected.

### FIELD OF THE DISCLOSURE

This disclosure generally relates to systems and methods for flying an aircraft. More particularly, this disclosure relates to systems and methods for enhancing aircraft displays.

### BACKGROUND

Aircraft commands may reduce dependency on pilot skill. For example, pitch commands typically originate from a flight director, are communicated to a display, and presented to the pilot.

Existing pitch command systems may be limited in their effectiveness, especially during takeoff and landing. For example, the pitch bar on some airplanes indicates zero at the beginning of takeoff. This continues until the plane reaches 80 knots, and then jumps to six degrees. When the nose wheel leaves the ground, the pitch bar jumps again, this time to 15 degrees.

Additional pilot training may be needed to supplement takeoff pitch commands. For example, a pilot may be trained to increase pitch at a specific pitch rate and may be cautioned not to over pitch, which could lead to a tailstrike, or under pitch, which could reduce the climb gradient leading to impact with rising terrain.

Such systems may rely on pilot skill to properly execute takeoff. Enhanced pitch commands may be available to supplement traditional aircraft pitch command systems, but those may be difficult to integrate with existing flight directors and displays. For example, existing systems may be configured to prevent third party access to the system, either to protect integrity or maintain FAA certifications.

### SUMMARY

This disclosure generally relates to systems and methods for flying an aircraft. More particularly, this disclosure relates to systems and methods for enhancing aircraft displays.

In one embodiment, a display system includes a first module that identifies a label in an ARINC 429 communication between a flight director and a display; a second module that removes flight director data from the ARINC 429 communication, the flight director data associated with the label; and a third module that inserts substitute data in the ARINC 429 communication, the display receiving the substitute data before an error is detected. The display system may advantageously provide enhanced commands, without triggering a time lapse error, for example, in the display system of the aircraft.

In some embodiments, the label is a pitch command label, the flight director data is a flight director pitch command, and the substitute data is a substitute pitch command.

In some embodiments, the display system may include a fourth module that identifies an aircraft take off or an aircraft landing, where the third module inserts the substitute pitch command when an aircraft take off or an aircraft landing is identified.

In some embodiments, the display system may include a fifth module that provides a notification that the substitute pitch command is displayed.

In some further embodiments, the notification may be an announcement.

In some embodiments, the display system may include a sixth module that receives a value representing an aircraft pitch and determines the substitute pitch command based on the value.

In some further embodiments, the sixth module receives a value representing aircraft acceleration when determining the substitute pitch command.

In some embodiments, the label is a localizer deviation command label, the flight director data is a localizer deviation, and the substitute data is a GPS lateral deviation.

In some embodiments, the label is a glide slope deviation label, the flight director data is a glide slope deviation, and the substitute data is a GPS vertical deviation.

In one embodiment, a display method includes identifying a label in an ARINC 429 bus between a flight director and a display, removing flight director data associated with the label from the ARINC 429 bus and inserting substitute data in the ARINC 429 bus before an error is triggered in the display.

In some embodiments, the label is a pitch command label, the flight director data is a flight director pitch command, and the substitute data is a substitute pitch command.

In some embodiments, the display method includes identifying an aircraft take off or an aircraft landing and inserting the substitute pitch command when an aircraft take off or an aircraft landing is identified.

In some embodiments, the display method includes providing a notification that the substitute pitch command is displayed. In some further embodiments, the notification may be an announcement.

In some embodiments, the display method includes receiving a value representing an aircraft pitch and determining the substitute pitch command based on the value.

In some further embodiments, determining the substitute pitch command includes accounting for aircraft acceleration.

In some embodiments, the label is a localizer deviation label, the flight director data is a localizer deviation command, and the substitute data is a GPS lateral deviation.

In some embodiments, the label is a glide slope deviation label, the flight director data is a glide slope deviation, and the substitute data is a GPS vertical deviation.

### BRIEF DESCRIPTION OF THE DRAWINGS

FIG. 1 depicts a command display system 100, in accordance with an embodiment.

FIG. 2 depicts a pitch command display system 200, in accordance with an embodiment.

FIG. 3 depicts a pitch command display system 300, in accordance with an embodiment.

FIG. 4 depicts pitch command display method 400, in accordance with an embodiment.

### DETAILED DESCRIPTION

In the following description of embodiments, reference is made to the accompanying drawings which form a part hereof, and in which it is shown by way of illustration specific embodiments in which the claimed subject matter may be practiced. It is to be understood that other embodiments may be utilized and structural changes may be made without departing from the scope of the claimed subject matter.

In some embodiments, substitute data replaces flight director data in a communication between the flight director and a display. In some embodiments, the replacement process does not trigger an error in the display, thereby permitting the substitute data to be received and displayed. Advantageously, the systems and methods may enhance command displays to a pilot without triggering an error.

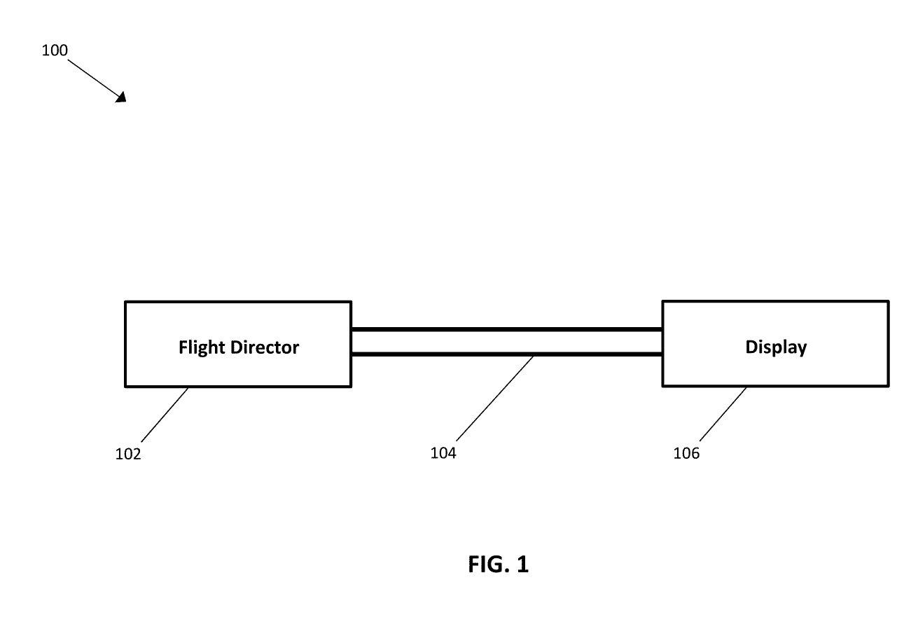

FIGS. 1-4 are primarily described with respect to substituting pitch commands in an ARINC 429 communication. It should be understood that the methods and systems described here apply equally to substituting other commands in an ARINC 429 including, without limitation, flight management commands. Other data may also be substituted, including substitution of GPS lateral and vertical deviations for traditional Localizer and Glide Slope deviations.

FIG. 1 depicts a command display system 100. System 100 includes a flight director 102, a display 106, and a bus 104 that provides a communication link between the flight director 102 and the display 106.

Flight director 102 receives information on flight parameters, such as altitude, speed, pitch, roll, etc. Using this information, flight director 102 produces instructions for the crew of the airplane in order to achieve a desired aircraft attitude, flight path, etc.

The instruction is communicated to the display 106 via bus 104. Different instructions may have different labels; in an ARINC 429 system, for example, a pitch command instruction is labelled as label 141.

System 100 may include an error checking routine that monitors for discrepancies in communications between flight director 102 and display 106. For example, the system may monitor the time between data packets and, if the time exceeds a threshold, an error may be trigged. In some embodiments, this error may include a message that the flight director has failed. In some embodiments, the threshold may be in seconds. In some embodiments, the system may monitor bits of voltage between data packets. For example, sequential words in the ARINC communication may be separated by at least 4 bit times of null or zero voltage—an error may be triggered if the gap is twice the normal separation (8 bit times, for example).

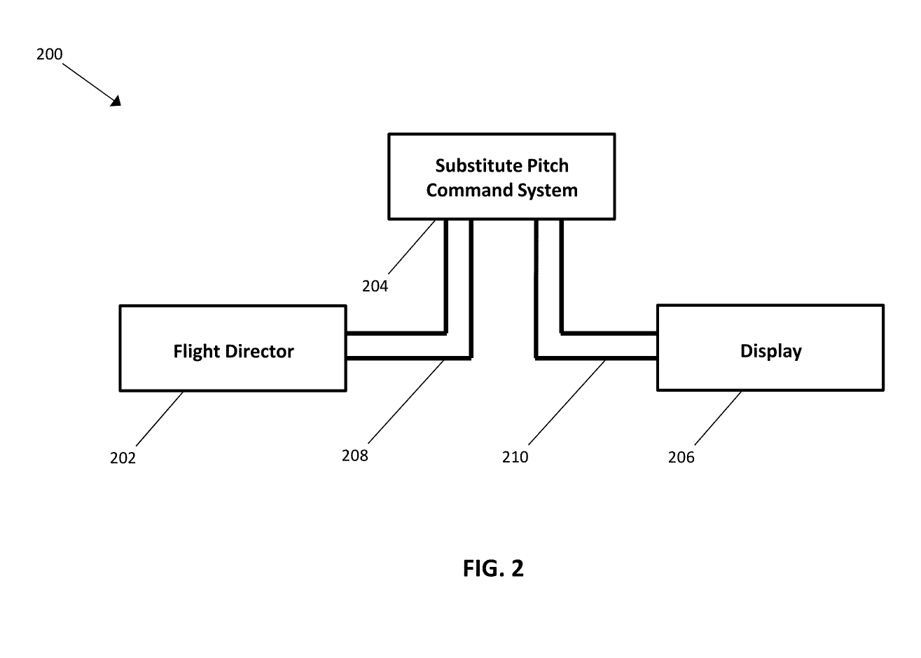

FIG. 2 depicts a pitch command display system 200, in accordance with an embodiment. System 200 includes a flight director 202, a substitute pitch command system 204, a display 206, a first bus 208, and a second bus 210.

Flight director 202 produces instructions for the crew of the airplane in order to achieve a desired aircraft attitude, flight path, etc. The instructions are communicated to display 206 via first bus 208, substitute pitch command system 204, and second bus 210. The communications may be labeled in accordance with an ARINC 429 standard.

Substitute pitch command system 204 monitors the communication from flight director 202 to display 206, identifies a pitch command label, removes a flight director pitch command from the communication, and inserts the substitute pitch command in the ARINC 429 communication. Substitute pitch command system 204 may remove the flight director pitch command and replace the substitute pitch command before an error checking routine in display 206 triggers an alarm.

In some embodiments, substitute pitch command system 204 monitors the first 8-bits of each ARINC 429 word in the communication between the flight director 202 and the display 206. When substitute pitch command 204 identifies a pitch command label in the first 8-bits, the following 24-bits of the ARINC 429 word are replaced with a substitute pitch command and a new ARINC 429 word is output. The procedure of identification, substitution, and output may be sufficiently fast that the display system 206 does not trigger an alarm.

In some embodiments, data bits from the flight director 202 to the display 206 are delayed so that all words—including those with substituted pitch commands—have a uniform bit length. In some further embodiments, the delay is not so long as to adversely impact the performance of devices utilizing data from the flight director 202.

In some embodiments, the substitute pitch command system 204 is monitored by a supervisory module (not shown) that monitors for errors in the identification, substitution, and output for the ARINC 429 word. In some embodiments, a parallel data stream may allow the flight director pitch command to pass through to the display 206 when the substitute pitch command system 204 is unable to identify, substitute, and output the new ARINC 429 word without triggering an alarm in the display 206.

In this way, pitch command system 204 may advantageously allow for substituting enhanced pitch commands in existing display systems.

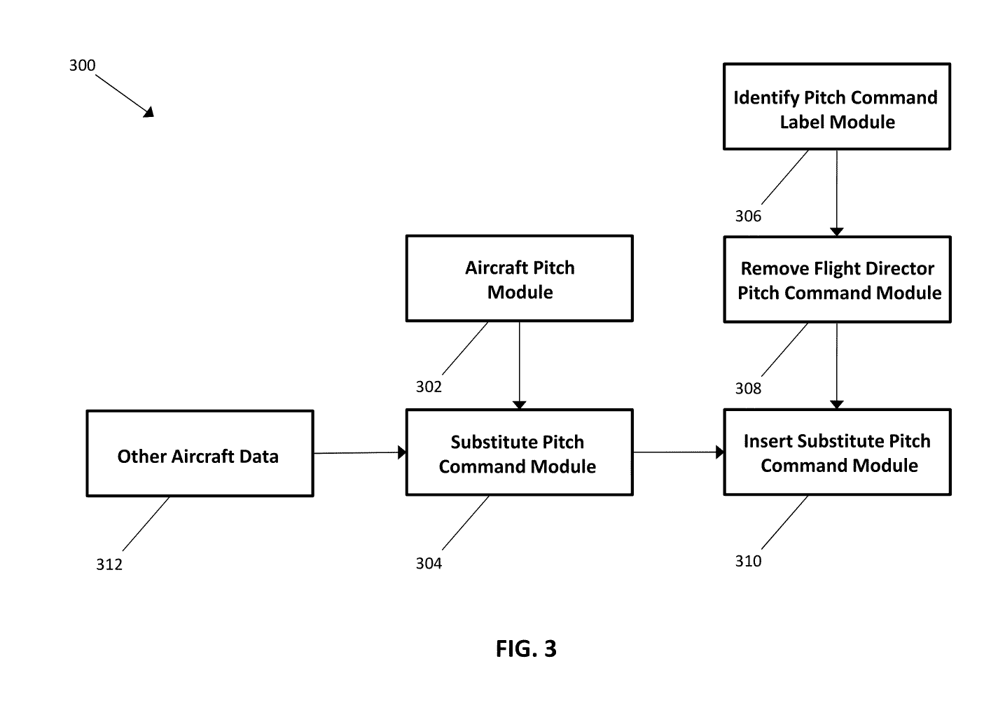

FIG. 3 depicts a pitch command display system 300, in accordance with an embodiment. System 300 includes an aircraft pitch module 302 that receives an aircraft pitch. In some embodiments, the aircraft pitch may be provided by a gyroscope or similar device for sensing the attitude of the aircraft. System 300 also includes a substitute pitch command module 304 that determines a pitch command based on the aircraft pitch received from module 302. In addition, other aircraft data 312 may also be fed to the substitute pitch command module including, but not limited to, weight-on-wheels, the aircraft acceleration, etc.

System 300 includes module 306 that identifies a pitch command label in an ARINC 429 communication between a flight director and a display. Once identified, module 308 removes a flight director pitch command from the ARINC 429 communication. Module 310 then inserts the substitute pitch command in the ARINC 429 communication before an error routine in the display triggers an alarm. The pitch command display system may advantageously allow for improved pitch commands, without triggering an internal error check in the display.

In some embodiments, system 300 includes a module (not shown) that identifies an aircraft take off or an aircraft landing, and module 310 inserts the substitute pitch command when an aircraft take off or an aircraft landing is identified. In some embodiments, system 300 may include a module (not shown) that provides a notification that the substitute pitch command is displayed. In some further embodiments, the notification may be an announcement. In some embodiments, module 304 considers aircraft acceleration when determining the substitute pitch command.

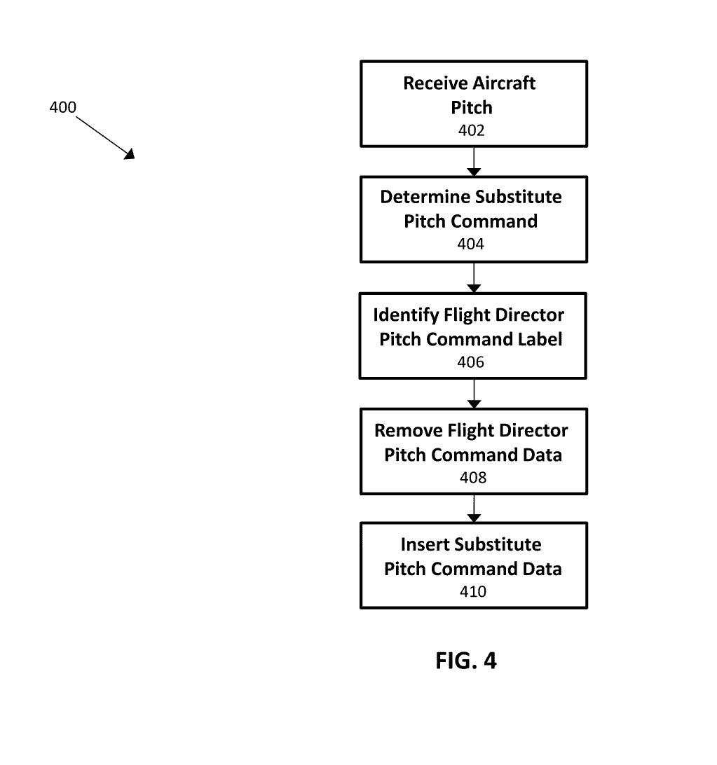

FIG. 4 depicts pitch command display method 400, in accordance with an embodiment. Method 400 includes receiving a value representing an aircraft pitch 402, determining a substitute pitch command based on the value 404, identifying a pitch command label in an ARINC 429 bus between a flight director and a display 406, removing a flight director pitch command from the ARINC 429 bus 408, the flight director pitch command associated with the pitch command label, and inserting the substitute pitch command in the ARINC 429 bus before an error is triggered in the display 410.

In some embodiments, pitch command display method 400 includes identifying an aircraft take off or an aircraft landing and inserting the substitute pitch command when an aircraft take off or an aircraft landing is identified. In some embodiments, pitch command display method 400 includes providing a notification that the substitute pitch command is displayed. In some further embodiments, the notification may be an announcement. In some embodiments, determining the substitute pitch command 404 includes accounting for an aircraft acceleration.

For illustration purposes, this description has been offered primarily with respect to substituting pitch commands in an ARINC 429 communication. It should be understood that the methods and systems described here apply equally to substituting other commands in an ARINC 429 including, without limitation, flight management commands. Other data may also be substituted, including substitution of GPS lateral and vertical deviations for traditional Localizer and Glide Slope deviations.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions.

What is claimed is:

1. An aircraft display system comprising:
a first module that identifies a label in an ARINC 429 communication between a flight director and a display,
a second module that removes flight director data from the ARINC 429 communication, the flight director data associated with the label, and
a third module that inserts substitute data in the ARINC 429 communication, the display receiving the substitute data before an error is detected.

2. The aircraft display system of claim 1, wherein the label is a pitch command label, the flight director data is a flight director pitch command, and the substitute data is a substitute pitch command.

3. The aircraft display system of claim 2 comprising a fourth module that identifies an aircraft take off or an aircraft landing and wherein the third module inserts the substitute pitch command when an aircraft take off or an aircraft landing is identified.

4. The aircraft display system of claim 2 comprising a fifth module that provides a notification that the substitute pitch command is displayed.

5. The aircraft display system of claim 4, wherein the notification comprises an announcement.

6. The aircraft display system of claim 2, comprising a sixth module that receives a value representing an aircraft pitch and that determines the substitute pitch command based on the value,

7. The aircraft display system of claim 6, wherein the sixth module receives a value representing an aircraft acceleration when determining the substitute pitch command.

8. The aircraft display system of claim 1, wherein the label is a localizer deviation label, the flight director data is a localizer deviation, and the substitute data is a GPS lateral deviation.

9. The aircraft display system of claim 1, wherein the label is a glide slope deviation label, the flight director data is a glide slope deviation, and the substitute data is a GPS vertical deviation.

10. A display method comprising:
identifying a label in an ARINC 429 bus between a flight director and a display, removing flight director data from the ARINC 429 bus, the flight director data associated with the label, and
inserting substitute data in the ARINC 429 bus before an error is detected.

11. The display method of claim 10, wherein the label is a pitch command label, the flight director data is a flight director pitch command, and the substitute data is a substitute pitch command.

12. The display method of claim 11 comprising identifying an aircraft take off or an aircraft landing and inserting the substitute pitch command when an aircraft take off or an aircraft landing is identified.

13. The display method of claim 11 comprising providing a notification that the substitute pitch command is displayed.

14. The display method of claim 11, wherein the notification comprises an announcement.

15. The display method of claim 11 comprising
receiving a value representing an aircraft pitch, and
determining the substitute pitch command based on the value,

16. The display method of claim 15, wherein determining the substitute pitch command comprises accounting for an aircraft acceleration.

17. The aircraft display system of claim 10, wherein the label is a localizer deviation label, the flight director data is a localizer deviation, and the substitute data is a GPS lateral deviation.

18. The aircraft display system of claim 10, wherein the label is a glide slope deviation label, the flight director data is a glide slope deviation, and the substitute data is a GPS vertical deviation.
